(19) United States
(12) Patent Application Publication
(10) Pub. No.: US 2007/0295540 A1
(43) Pub. Date: Dec. 27, 2007

(54) Device feature activation

(76) Inventor: Mikko A. Nurmi, Tampere (FI)

Correspondence Address: PERMAN & GREEN, 425 POST ROAD, FAIRFIELD, CT, 06824, US

(21) Appl. No.: 11/473,836

(22) Filed: Jun. 23, 2006

(51) Int. Cl. G06F 3/041

(52) U.S. Cl. 178/18.01

(57) ABSTRACT

A method of activating functions of a device. The method includes detecting at least one input to a touch display of the device, determining at least one dimension of a movement of the input, and activating or deactivating a function of the device in dependence upon the movement.

### 1. FIELD OF THE INVENTION

The disclosed embodiments relate to touch screen devices and, more particularly, to activating features of touch screen devices.

### 2. BRIEF DESCRIPTION OF RELATED DEVELOPMENTS

There are different situations where the primary use of a touch screen device by a user is the inputting of text using a pointing device. Examples of such primary uses can include e-mails, short messages (SMS), multimedia messages (MMS), instant messages (IM), notepad entries, word processor entries, calendar entries, To-Do entries and the like.

In conventional touch screen devices each of these features or functions is accessed through various keystrokes on a keypad or through a series of selections made on the user interface of the touch screen device. Not all uses or software functions are easily accessed using the pointing device in these conventional devices. Some uses or functions are only accessible through a complicated and time-consuming interaction using the pointing device or are otherwise accessed via the keypad. In other conventional devices some of the uses or software functions may not be accessible at all when using the pointing device.

It would be advantageous to be able to automatically activate features of a device depending on a type of user input to the touch screen of the device.

### SUMMARY

The disclosed embodiments are direct to activating functions of a device. In one aspect, the method includes detecting at least one input to a touch display of the device, determining at least one dimension of a movement of the input, and activating or deactivating a function of the device in dependence upon the movement of the input.

In another aspect, a method includes detecting an input of the text on a touch enabled display of a device, determining an orientation of an input sequence of the inputted text, and opening an application of the device that is associated with the orientation of the input sequence of the inputted text.

In one aspect an apparatus includes a display processor coupled to a touch screen, an input detection unit coupled to the display processor that receives a first input in the form of a user forming text on the touch screen with a pointing device, an input recognition unit coupled to the display processor that detects an orientation of a sequence of the text being inputted and a processing unit that activates at least one function or application of the apparatus that is associated with the detected orientation.

In another aspect, a computer program product includes a computer useable medium having computer readable code means embodied therein for causing a computer to activate functions of a device. The computer readable code means in the computer program product includes computer readable code means for causing a computer to detect at least one input to a touch display of the device, computer readable code means for causing a computer to determine at least one dimension of a movement of the input and computer readable code means for causing a computer to activate or deactivate a function of the device in dependence upon the movement of the input.

### BRIEF DESCRIPTION OF THE DRAWINGS

The foregoing aspects and other features of the present invention are explained in the following description, taken in connection with the accompanying drawings, wherein:

FIG. 1 shows a device incorporating features of an embodiment;

FIG. 2 shows another device incorporating features of an embodiment;

FIGS. 3 and 4 illustrate text input directions in accordance with an embodiment;

FIG. 5A illustrates a device incorporating features of an embodiment;

FIG. 5B illustrates a device incorporating features of an embodiment;

FIG. 6 is a flow diagram of a method in accordance with an embodiment;

FIG. 7 is a block diagram of one embodiment of a typical apparatus incorporating features of the present invention that may be used to practice the present invention; and

FIG. 8 shows another device in accordance with an embodiment.

### DETAILED DESCRIPTION OF THE EXEMPLARY EMBODIMENT(s)

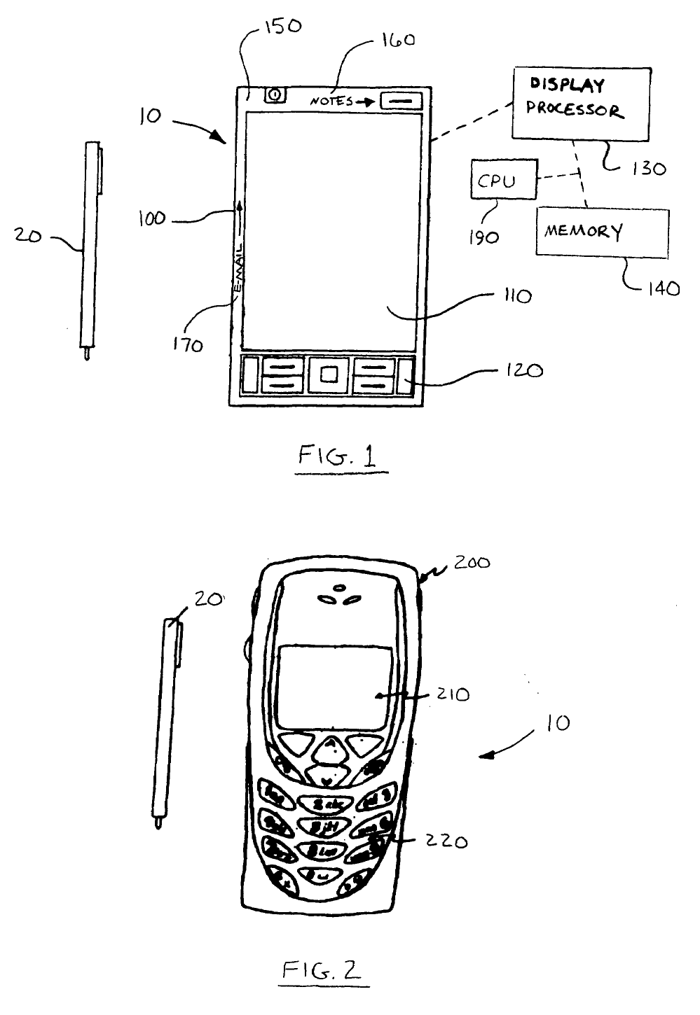

FIG. 1 illustrates a system incorporating features of one exemplary embodiment. Although the present embodiments will be described with reference to the exemplary embodiments shown in the drawings and described below, it should be understood that the present invention could be embodied in many alternate forms of embodiments. In addition, any suitable size, shape or type of elements or materials could be used.

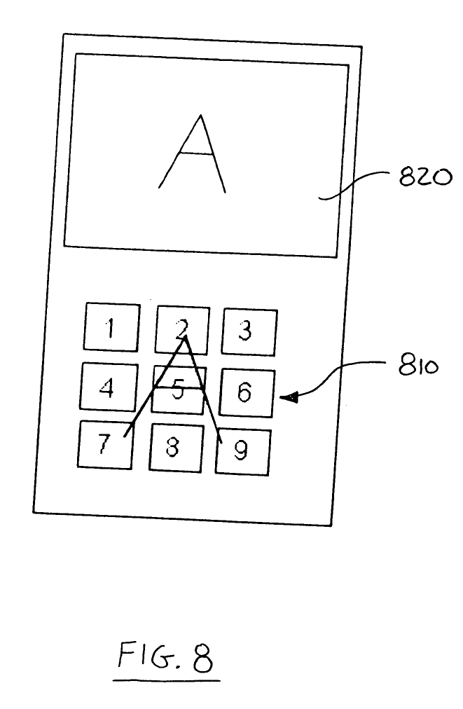

FIG. 1 shows a device 10 including a touch screen display 110 and a pointing device 20. The pointing device 20, such as for example, a stylus, pen or simply the user's finger can be used with the touch screen display 110. In alternate embodiments any suitable pointing device may be used. The display 110 and the pointing device 20 form a user interface of the device 10, which may be configured as a graphical user interface. The device 10 may also include a display processor 130 coupled to a memory 140 that stores a gesture or stroke based algorithm for causing the display processor 130 to operate in accordance with this invention. The memory 140 may also store one or more software applications that run on the device 10. A processing unit 190 may be coupled to the display processor 130 and the memory 140 for initiating or launching the software applications. A first communication or data link or connection may exist between the display 110 and the processor 130 for the processor 130 to receive coordinate information that is descriptive or indicative of the location of the tip or end of the pointing device 20 relative to the surface of the display 110. The display 110 is typically pixelated, and may contain liquid crystal (LC) or some other type of display pixels. The display may be configured to recognize simultaneous inputs (e.g. touch) where the simultaneous inputs occur at different places on the display. In alternate embodiments any display may be utilized. In other alternate embodiments, the device may include a touch sensitive keypad as shown in FIG. 8. The keys of the touch sensitive keypad may be used in a conventional manner while at the same time be configured to function in a manner substantially similar to that of a touch screen display. For example, a user may make a mark such as the letter “A” in the center of the keypad 810 using any suitable pointing device (e.g. the user finger or a stylus) so that the letter “A” appears at the center of the display 820. The embodiments described below apply equally to a display such as, for example, a touch screen display and the touch sensitive keypad.

The display processor 130 may generally provide display data directly or indirectly to the display 110 over, for example, a second communication or data link or connection for activating desired pixels, as is well known in the art. A given coordinate location, such as for example an x-y location on the surface of the display 110 may correspond directly or indirectly to one or more display pixels, depending on the pixel resolution and the resolution of the touch screen itself. A single point on the touch screen display 110 (a single x-y location) may thus correspond to one pixel or to a plurality of adjacent pixels. Differing from a single point, a path, stroke, line or gesture (as these terms are used interchangeably herein) that may be used to form text or activate a device function may have a starting x-y point and an ending x-y point, and may include some number of x-y locations between the start and end points. As used herein the term “text” refers to a single alphanumeric character and strings of alphanumeric characters (i.e. words, sentences and the like) including punctuation marks. In alternate embodiments any suitable gestures, such as lines or graphical marks, may be used.

Bringing an end of the pointing device 20 in proximity to or in contact with the surface of the display 110 may mark a starting point of the text. Subsequently moving or lifting the end of the pointing device 20 away from the surface of the display 110 may mark the end point of the text. In one embodiment, the pointing device 20 does not need to make contact with the surface of the display 110 to cause the formation of, or recognition of, an input signal to form a gesture.

In accordance with one embodiment, the device 10, may be for example, the PDA 100 illustrated in FIG. 1. The PDA 100 may have a keypad 120, a touch screen display 110 and a pointing device 20 for use on the touch screen display 110. In accordance with another embodiment, the device 10 may be a mobile cellular device 200 shown in FIG. 2. The device 200 may also have a touch screen display 110 a keypad 120 and a pointing device 20. In still other alternate embodiments, the device 10 may be a personal communicator, a tablet computer, a laptop or desktop computer, or any other suitable device capable of containing the touch screen display 110 and supported electronics such as the display processor 130 and memory 140. In other alternate embodiments, the display and/or other hardware and controls associated with the device 10 may be peripheral devices that may not be located within the body of the device 10. In further alternate embodiments, the device 10 may have multiple displays where, for example, input on one display may affect the behavior (e.g. what is presented, orientation of objects, etc.) of the other displays. The exemplary embodiments herein will be described with reference to the PDA 100 for exemplary purposes only and it should be understood that the embodiments could be applied equally to any suitable device incorporating a touch screen display.

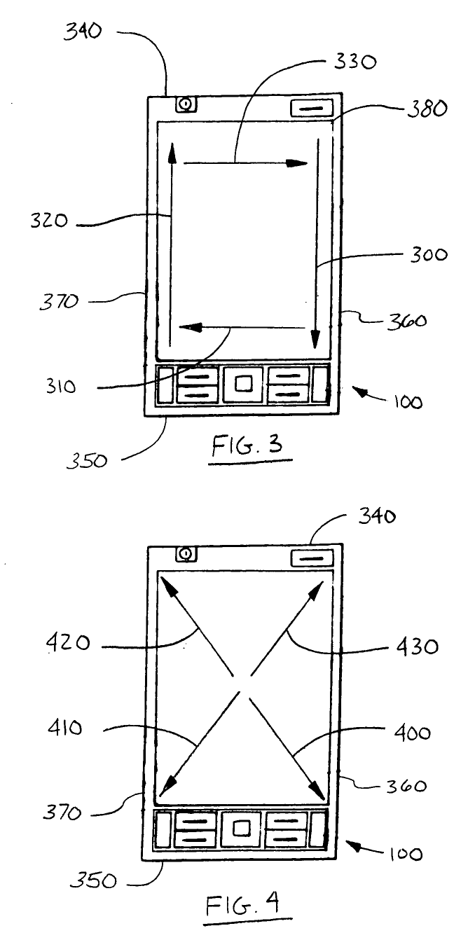

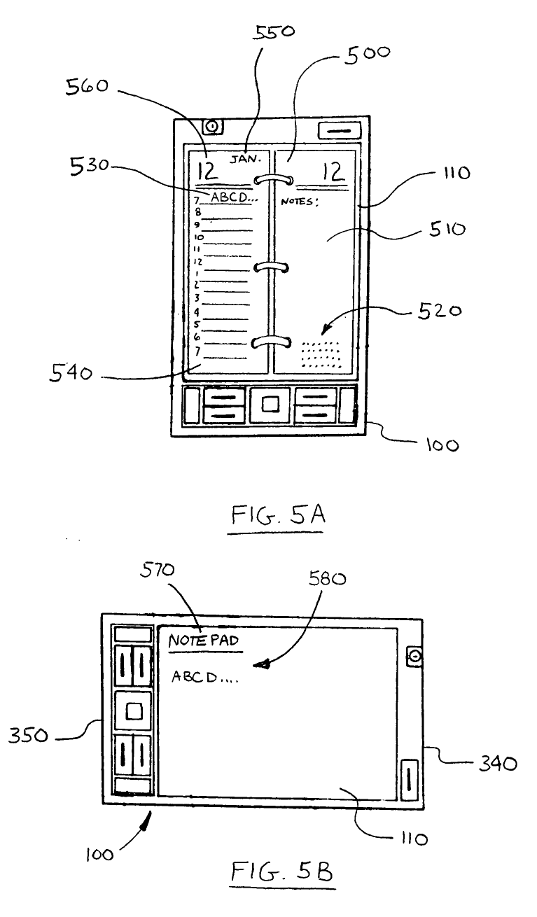

It is understood that when inputting text into a device such as, for example, a PDA 100 in a typical or otherwise conventional fashion that the PDA 100 is held with its bottom portion 350 closest to the user (i.e. the normal operating orientation of the touch screen device) so that text is input from left to right when using, for example, the English language. However, referring to FIGS. 3 and 4 and in accordance with one embodiment, the writing, or text can be input into and recognized by the PDA 100 in a variety of directions. While term “text” will be used herein for purposes of describing the disclosed embodiments, it should be understood that the disclosed embodiments can be applied using any style of input to the device. An input can include for example, a marking such as a line that can be straight, wavy, or jagged, a string of characters (e.g. word or sentence) or a single character (e.g. a single letter or number). Alternatively, the input could be a random series of markings that is inputted on the screen of the device. However, no matter what the input comprises, whenever more than one input is made on the touch screen, the orientation of the input will be in a certain direction with respect to the display 110.

For example, text may be input in direction 300 from the top 340 of the PDA 100 to the bottom 350 of the PDA 100 or vice versa as indicated by arrow 320. Text may also be input from the left side 370 of the PDA to the right side 360 of the PDA 100 as indicated by arrow 330 or vice versa as indicated by arrow 310. In alternate embodiments, the text may be input diagonally as shown in FIG. 4 and indicated by arrows 400, 410, 420, 430.

These different text input directions will be referred to herein as “text orientations” and may be facilitated by rotating the PDA 100 to an angle corresponding to a desired text orientation. For example, if a user desires to input text in orientation 310 the user may rotate the PDA 100 so that the top 340 of the PDA 100 is closest to the user, when for example the English language is being used. In alternate embodiments any suitable user language may be used with the touch screen device and the text orientations may change according to a specified user language. For example, when the Arabic language is used, text is normally written from right to left so when text is input in orientation 310 the bottom 350 of the PDA 100 would be closest to the user.

The above described text orientations, for example, may represent shortcuts to a specified device function or application that is associated with a given text orientation. The memory 140 of the PDA 100 may include algorithms that cause the display processor 130 to automatically recognize the different text orientations 300-330 and 400-430, as well as the text itself, as a user inputs the text. The memory 140 may also include algorithms that may be used by processor 190 and display processor 130 for launching and causing features, functions and applications of the PDA 100 to activate. For example, software applications or functions can be activated when a certain sequence of movement and direction of the input to the device 10 is detected.

For example, a messaging application may be opened when text is input in orientation 330 or a notes application may be opened when text is input in orientation 310.

The function, feature or application to be associated with and activated by any given text orientation may be predefined during manufacture of the device or it may be set by the user of the PDA 100. For example, certain text orientations may be associated with applications of the touch screen device such as e-mails, short messages (SMS), multimedia messages (MMS), instant messages (IM), notepads, word processors, calendars, To-Dos, spreadsheets or any other suitable functionality that may be stored and run within the touch screen device. In alternate embodiments, each text orientation may be associated with more than one function in that, for example, the display processor may recognize function names as well as the direction of the written text. For example when the word “calendar” is written on the touch screen in direction 330 the display processor recognizes both the word “calendar” and the direction 330 and causes the calendar application to be launched. When the word “notes” is written on the touch screen in direction 330 the display processor similarly recognizes both the word “notes” and the direction 330 and causes a notes application to be launched instead of the calendar function. In alternate embodiments, a combination of a word and a direction may be used to launch an application in different orientations. For example, if the word “notes” is input on the display in the direction 330, the notepad application may be launched so that the contents of the notepad application are read from left to right. If the word “notes” is input in direction 350 the notepad application may be launched so the contents of the notepad application are read from right to left.

Any suitable method of associating the device functions with a specified text orientation may be used. For example, a user may associate text orientation 330 with a calendar application so that when text is input in a direction 330, an algorithm within the memory 140 may cause the display processor 130 to display, for example, the calendar 500 of the PDA 100 as can be seen in FIG. 5A. In this example, the touch screen device 10 may have up to eight shortcuts associated with the text orientations, however the embodiments are not limited to eight shortcuts as any number (more or less than eight) of text orientation/device software application or function associations can be envisioned using the concept of the embodiments. In alternate embodiments, a combination of direction of an input and a location (e.g. starting point, ending point, etc.) of that input on, for example, the display may also determine which application or function is to be activated and in which orientation that application or function is to be presented. For example, referring to FIG. 3, corner 380 of the device may be associated with the calendar application of the device so that when an input is made, for example, starting in corner 380 in direction 300 the calendar may be launched and the contents of the calendar may be presented on the display to read from top 340 to bottom 350.

The meaning of the shortcut (i.e. the shortcut description) associated with each of the different text orientations may be written, silk screened, embossed, engraved, molded in or otherwise formed on the housing 150 of the touch screen device 100. For example, if orientation 330 activates a notes application an indicator such as indicator 160 may be written, silk screened, embossed, engraved, molded in or otherwise formed on the top 340 portion of the housing 150 as shown in FIG. 1. Likewise, if for example, orientation 320 activates an e-mail application an indicator such as indicator 170 may be written, silk screened, embossed, engraved, molded in or otherwise formed on the left side 370 portion of the housing 150. In alternate embodiments, the shortcut description may be displayed along a corresponding side of the touch screen display 110 itself such as when, for example, a user configures the shortcuts. The display of the shortcut definition directly on the touch screen display may allow the shortcut definition to be easily changed when a user redefines the shortcut. In other alternate embodiments the shortcut description may be displayed or presented in any suitable manner on any suitable area of the touch screen device.

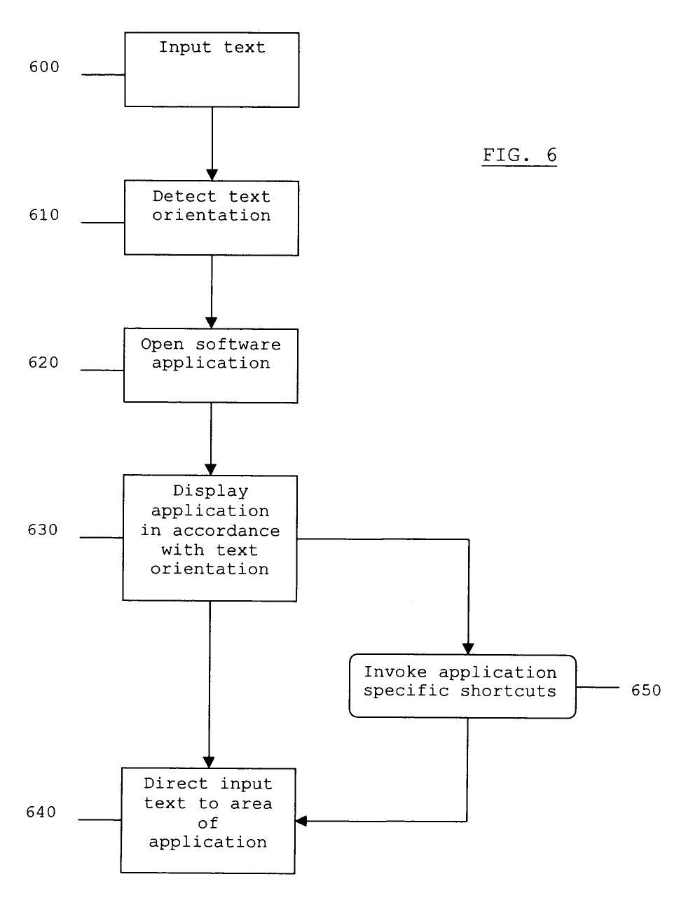

Referring to FIG. 5A, the operation of an exemplary embodiment will be described. A user of the device 10 such as PDA 100 may, for example, input text, such as text 530 in direction 330 by placing the pointing device 20 on or near the touch screen 110 and writing a desired text (FIG. 6, Block 600). The display processor 130 may detect or recognize the direction (i.e. direction 330) the text is being input (FIG. 6, Block 610). The detection of direction 330 by the display processor 130 may cause processor 190 via an algorithm within the memory 140 to open a software application or function associated with direction 330 that is to be displayed by the display processor 130 on the touch screen display 110 (FIG. 6, Block 620). In this example the calendar application 500 will be associated with the text orientation 330. The calendar 500 may be displayed on the touch screen 110 having the look of a conventional paper calendar. The calendar may be a personalized calendar including the month 550, the date 560, a day planner 540, a notes section 510 and a “month at a glance” section 520. The day planner may contain hourly entries for the day that may be categorized in groups such as by work, family, or hobbies groups.

The display processor 130 may be configured to display the software function in such a manner so that the display corresponds with the orientation of the input text (FIG. 6, Block 630). The display processor 130 may automatically “rotate” the items (e.g. the software application) shown on the display 110 in accordance with the detected text input direction. In this example and as shown in FIG. 5A, because the text was input in direction 330 (e.g. from left to right) the calendar function 500 may be displayed to be read from the left side 370 of the PDA 100 to the right side 360 of the PDA 100. In alternate embodiments and as shown in FIG. 5B, if text is input in, for example, direction 320 (e.g. from bottom to top) the display processor may automatically “rotate” the items (e.g. icons, character strings, pictures, graphics, etc.) corresponding to the software application on the touch screen display 110 so that when displayed, the contents of the software application, such as for example the contents 580 of a notepad 570, may be read from the bottom 350 of the PDA 100 to the top 340 of the PDA 100. In other alternate embodiments, the device may present a choice to the user via, for example, a dialogue box or the user may configure the device as to whether or not the device is to rotate the items on the display to correspond to the detected text input direction.

Upon displaying the calendar function 500 on the touch screen display 110, the display processor may direct the input text 530 to a certain area of the calendar such as the day planner 540 (FIG. 6, Block 640). The area the text is directed to may be preset during the manufacture of the device or it may be user defined. In alternate embodiments, once the software application is initiated and displayed on the touch screen 110 a new set of application specific text orientation shortcuts may be invoked (FIG. 6, Block 650). The application specific shortcuts may also be definable by a user of the device. For example, while a user is working with the calendar function 500 a set of shortcuts may be configured or defined so that text written in direction 320 will be entered in the day planner section 540 under the work category while text entered in direction 330 may be entered in the day planner section 540 under the family category.

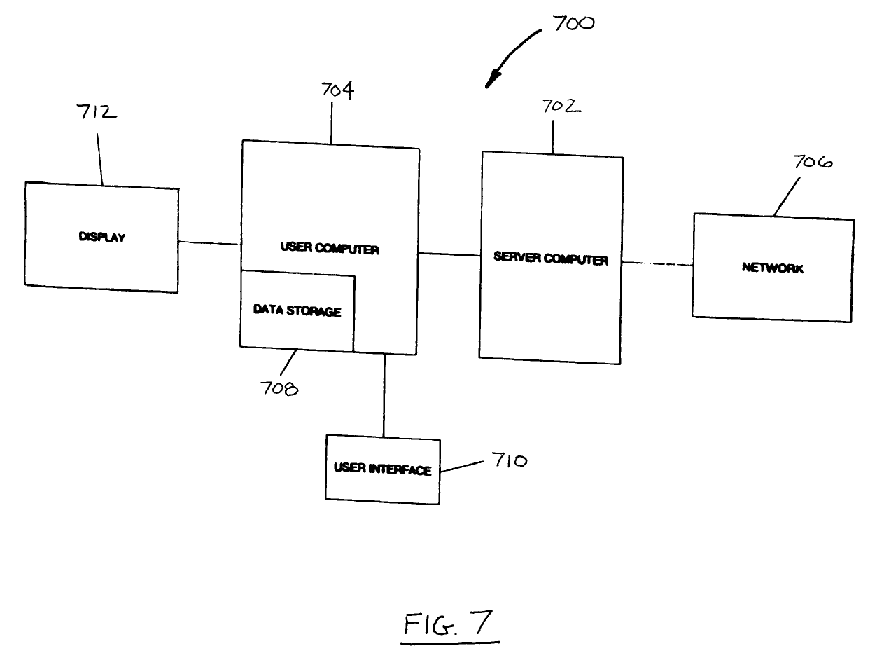

The disclosed embodiments may also include software and computer programs incorporating the process steps and instructions described above that are executed in different computers. FIG. 7 is a block diagram of one embodiment of a typical apparatus 700 incorporating features that may be used to practice the present invention. As shown, a computer system 702 may be linked to another computer system 704, such that the computers 702 and 704 are capable of sending information to each other and receiving information from each other. In one embodiment, computer system 702 could include a server computer adapted to communicate with a network 706. Computer systems 702 and 704 can be linked together in any conventional manner including, for example, a modem, hard wire connection, or fiber optic link. Generally, information can be made available to both computer systems 702 and 704 using a communication protocol typically sent over a communication channel or through a dial-up connection on ISDN line. Computers 702 and 704 are generally adapted to utilize program storage devices embodying machine readable program source code which is adapted to cause the computers 702 and 704 to perform the method steps of the present invention. The program storage devices incorporating features of the invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 702 and 704 may also include a microprocessor for executing stored programs. Computer 702 may include a data storage device 708 on its program storage device for the storage of information and data. The computer program or software incorporating the processes and method steps incorporating features of the present invention may be stored in one or more computers 702 and 704 on an otherwise conventional program storage device. In one embodiment, computers 702 and 704 may include a user interface 710, and a display interface 712 from which features of the present invention can be accessed. The user interface 710 and the display interface 712 can be adapted to allow the input of queries and commands to the system, as well as present the results of the commands and queries.

It should be understood that the foregoing description is only illustrative of the invention. Various alternatives and modifications can be devised by those skilled in the art without departing from the invention. Accordingly, the disclosed embodiments are intended to embrace all such alternatives, modifications and variances which fall within the scope of the appended claims.

What is claimed is:

1. A method comprising:
detecting at least one input to a touch display of a device;
determining at least one dimension of a movement of the input; and
activating or deactivating a function of the device in dependence upon the movement of the input.

2. The method of claim 1 further comprising activating an application of the device in dependence upon the movement of the input.

3. The method of claim 1 further comprising determining at least one dimension of a direction of the movement of the input to the device.

4. The method of claim 1 further comprising detecting a text input on the touch screen display and determining a direction of each successive text input relative to the touch screen.

5. The method of claim 1 further comprising activating a text field of the device in dependence of the determination of a direction of the movement of the input.

6. The method of claim 1 wherein the movement, relative to the touch screen, is left to right, right to left, bottom to top, or top to bottom.

7. The method of claim 1 wherein a direction of the movement is relative to the touch screen of the device.

8. The method of claim 1 wherein the movement of the input is along a substantially horizontal, vertical or diagonal line relative to the touch screen of the device.

9. The method of claim 1 wherein the device is a PDA device.

10. The method of claim 1 wherein the device is a mobile telecommunication device.

11. A method comprising:
detecting an input of the text on a touch enabled display of a device;
determining an orientation of an input sequence of the inputted text; and
opening an application of the device that is associated with the orientation of the input sequence of the inputted text.

12. The method of claim 12, wherein an association between the application and the orientation of the input sequence of the text is user defined.

13. The method of claim 11 further comprising displaying the application so a content of the application is readable in the direction of the orientation of the input sequence of the text.

14. The method of claim 13, wherein the displayed application is rotated on the display of the touch screen device in correspondence to the orientation of the inputted text.

15. The method of claim 1 further comprising directing the inputted text to a predetermined area of the software application in dependence upon the orientation of the input sequence of the inputted text.

16. The method of claim 1 further comprising displaying at least one application shortcut on the display in dependence upon the orientation of the input sequence of the text, wherein the at least one application shortcut is associated with a corresponding text orientation.

17. An apparatus comprising:
a display processor coupled to a touch screen;
an input detection unit coupled to the display processor that receives a first input in the form of a user forming text on the touch screen with a pointing device;
an input recognition unit coupled to the display processor that detects an orientation of a sequence of the text being inputted; and
a processing unit that activates at least one function or application of the apparatus that is associated with the detected orientation.

18. The apparatus of claim 17, wherein the display processor is configured to rotate an application open on the device to correspond with the detected orientation.

19. The apparatus of claim 18, wherein the display processor is configured to automatically rotate visual information presented by the application on the touch screen so that the visual information is read in a direction of the detected orientation.

20. The apparatus of claim 17, wherein the display processor is configured to automatically display the inputted text in a predetermined area of the display in dependence of the detected orientation.

21. A computer program product comprising:
a computer useable medium having computer readable code means embodied therein for causing a computer to activate functions of a device, the computer readable code means in the computer program product comprising:
computer readable code means for causing a computer to detect at least one input to a touch display of the device;
computer readable code means for causing a computer to determine at least one dimension of a movement of the input; and
computer readable code means for causing a computer to activate or deactivate a function of the device in dependence upon the movement of the input.
